(19) United States
(12) Patent Application Publication
(10) Pub. No.: US 2016/0037253 A1
(43) Pub. Date: Feb. 4, 2016

(54) PORTABLE SPEAKER SYSTEM

(71) Applicant: Goal Zero LLC, Bluffdale, UT (US)

(72) Inventors: Robert E. Workman, Morgan, UT (US); Norman L. Krantz, Draper, UT (US); Henry J. Howell, Herriman, UT (US); Fred K. Lillywhite, Cottonwood Heights, UT (US)

(21) Appl. No.: 14/447,437

(22) Filed: Jul. 30, 2014

(51) Int. Cl. H04R 1/28

(52) U.S. Cl. CPC H04R 1/2826; H04R 1/2803

(57) ABSTRACT

A portable speaker assembly includes a body, a speaker, and a membrane. The body includes a first plate spaced from a second plate, and a surface of the body defines a port having a first cross-sectional area. The speaker is disposed along a surface of the first plate and extends toward the second plate. The membrane is configured to direct sound waves toward the port and is positioned between the first plate and the second plate. The membrane has a second cross-sectional area that is larger than the first cross-sectional area of the port.

### BACKGROUND

The present disclosure relates to portable speaker systems. In particular, the present disclosure relates to a portable speaker system that includes a passive radiator.

Speaker systems may include one or more speakers disposed along a surface of a cabinet or housing. Users may listen to music or other sounds using the speaker system. Portable speaker systems may be used to supplement or augment the sound provided by speakers of electronic devices. Traditionally, the speakers of electronic devices are small and offer reduced acoustic performance relative to speaker systems having larger or more powerful speakers. Bass reflex systems may be added to augment the acoustic output provided by the speakers of electronic devices.

### SUMMARY

One embodiment of the disclosure relates to a portable speaker assembly that includes a body, a speaker, and a membrane. The body includes a first plate spaced from a second plate, and a surface of the body defines a port having a first cross-sectional area. The speaker is disposed along a surface of the first plate and extends toward the second plate. The membrane is configured to direct sound waves toward the port and is positioned between the first plate and the second plate. The membrane has a second cross-sectional area that is larger than the first cross-sectional area of the port.

Another embodiment of the disclosure relates to a portable speaker assembly that includes a shell, a speaker, and a membrane. The shell includes a first face and an opposing second face, and the shell defines an internal volume and a port having a first cross-sectional area. The speaker is disposed along the first face and extends toward the opposing second face. The membrane is configured to direct sound waves toward the port and is positioned within the internal volume of the shell. The membrane has a second cross-sectional area that is larger than the first cross-sectional area of the port.

Still another embodiment of the disclosure relates to a portable speaker assembly that includes a housing defining an internal volume and a bass port, a first speaker coupled to the housing and positioned on a first lateral side of the bass port, a second speaker coupled to the housing and positioned on a second lateral side of the bass port, and a passive radiator including a membrane and configured to direct sound waves through the bass port. The membrane is disposed within the internal volume of the housing and has a cross-sectional area that is larger than the bass port.

The invention is capable of other embodiments and of being carried out in various ways. Alternative exemplary embodiments relate to other features and combinations of features as may be recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a top perspective view of a portable speaker assembly configured in a closed arrangement, according to an exemplary embodiment;

FIG. 2A is a bottom perspective view of a portable speaker assembly configured in a closed arrangement, according to an exemplary embodiment;

FIG. 2B is a sectional view of a clip for a portable speaker assembly, according to an exemplary embodiment;

FIG. 3 is a top perspective view of a portable speaker assembly configured in an open arrangement, according to an exemplary embodiment;

FIG. 4 is a bottom perspective view of a portable speaker assembly configured in an open arrangement, according to an exemplary embodiment;

FIG. 5 is a sectional view of the portable speaker assembly shown in FIG. 1, according to an exemplary embodiment;

FIG. 6 is an exploded view of a portable speaker assembly, according to an exemplary embodiment;

FIG. 7 is a top perspective view of a membrane and a conduit for a portable speaker assembly, according to an exemplary embodiment;

FIG. 8 is a bottom perspective view of a membrane and a conduit for a portable speaker assembly, according to an exemplary embodiment;

FIG. 9 is a sectional view of the membrane and the conduit shown in FIGS. 7-8, according to an exemplary embodiment; and

FIGS. 10-11 are top perspective views of a portable speaker assembly that includes a solar panel, according to an alternative embodiment.

### DETAILED DESCRIPTION

According to an exemplary embodiment, a portable speaker assembly includes a speaker (e.g., active driver, main driver, etc.) and a passive radiator (e.g., drone cone). A user may couple the portable speaker assembly with an electronic device (e.g., a portable music player, a cellular telephone, a tablet, a laptop computer, etc.). Sound normally produced by speakers associated with the electric device may be produced by the portable speaker assembly. In one embodiment, the portable speaker assembly is powered (e.g., with a battery, with a USB or other hard-wired electrical power connection, etc.) such that user-desired sound may be produced (e.g., music may be played) without draining the battery associated with the portable electronic device.

In one embodiment, the passive radiator includes a membrane but does not include a voice coil or a magnet assembly. The passive radiator may improve the low-frequency acoustic performance of the portable speaker assembly. In one embodiment, the speaker and the passive radiator are positioned within a body (e.g., housing, shell, etc.) that defines an internal volume. By way of example, the speaker and the passive radiator may have frames that are coupled to a plate of the body and extend inward into the internal volume. According to an exemplary embodiment, the body is substantially sealed such that pressure variations within the internal volume of the body actuate the membrane, thereby directing sound waves toward a listener. By way of example, the pressure variations within the internal volume of the body may be produced by the speaker (e.g., by a cone or other moveable component of the speaker) such that the waves produced by the passive radiator correspond to (e.g., relate to, are timed with, etc.) those produced by the speaker.

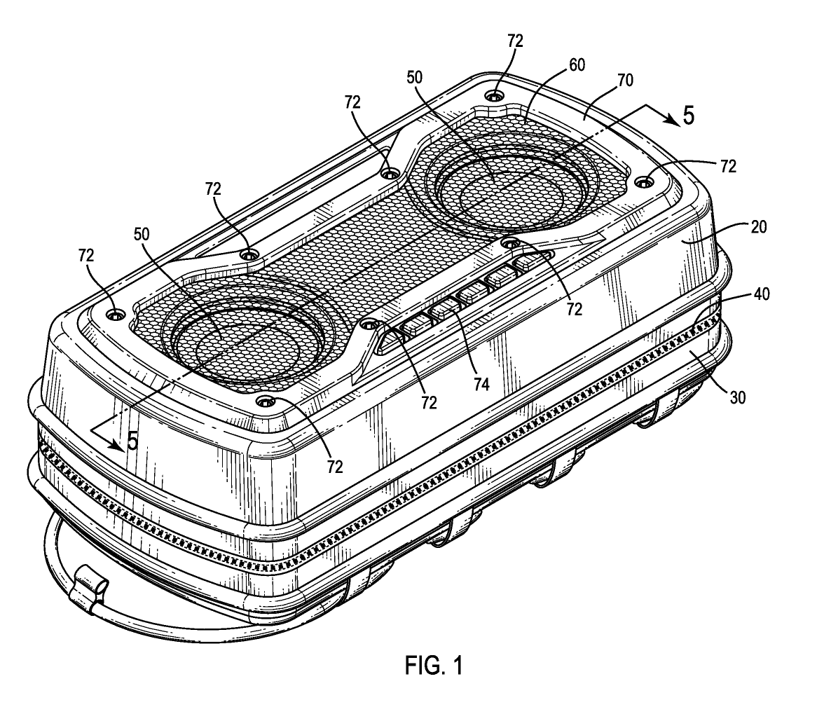

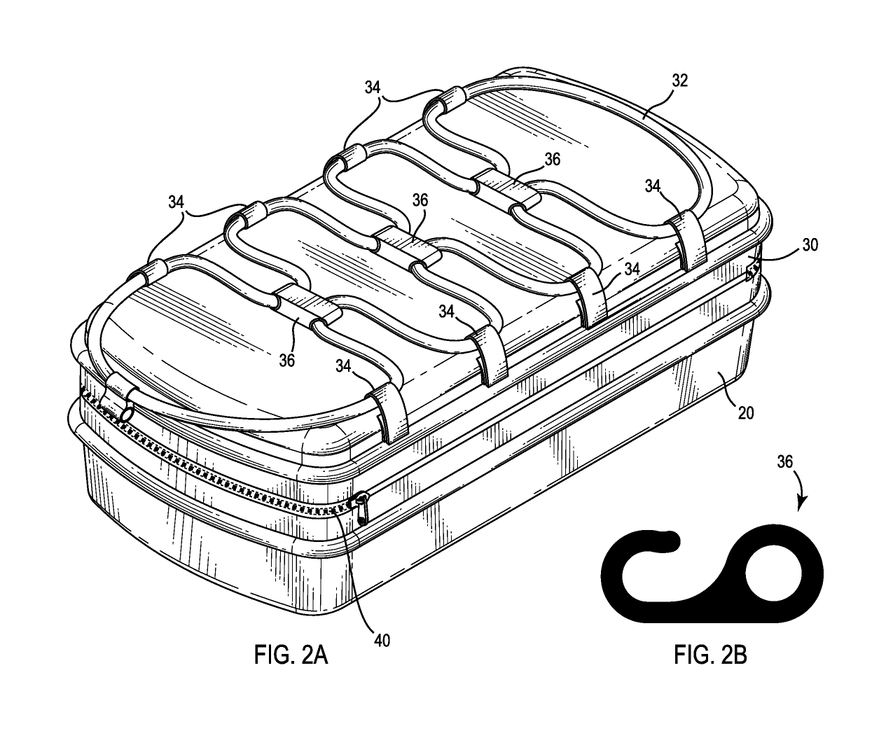

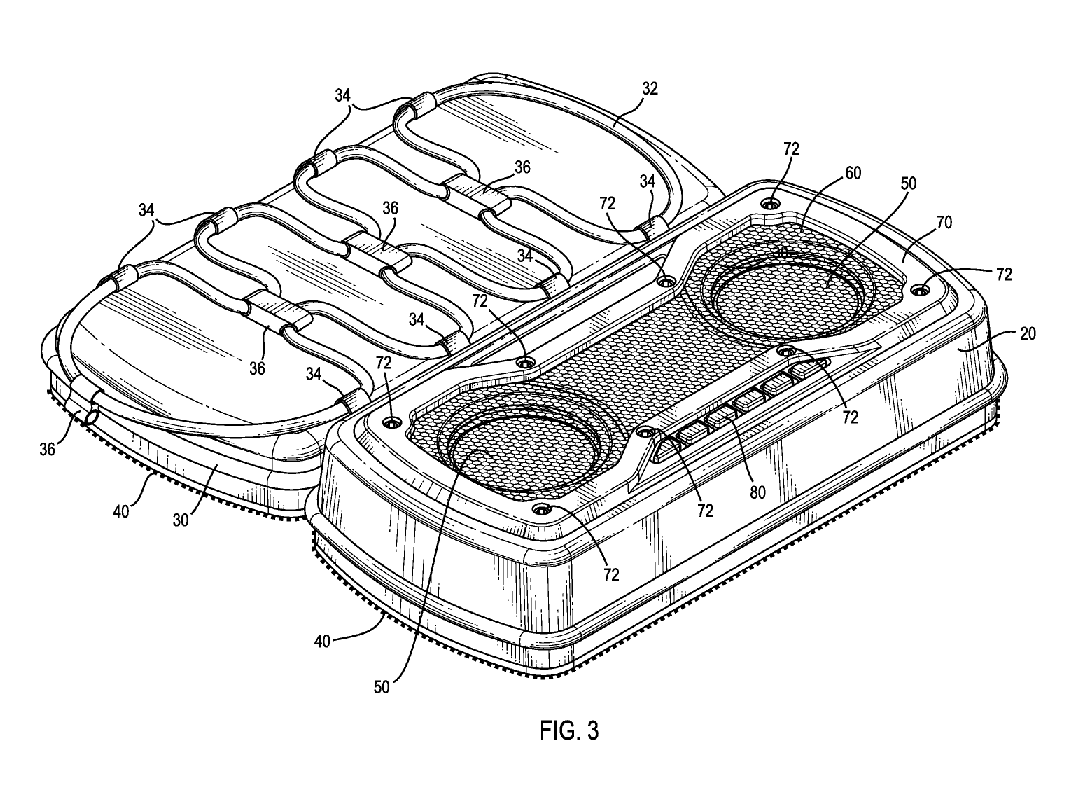

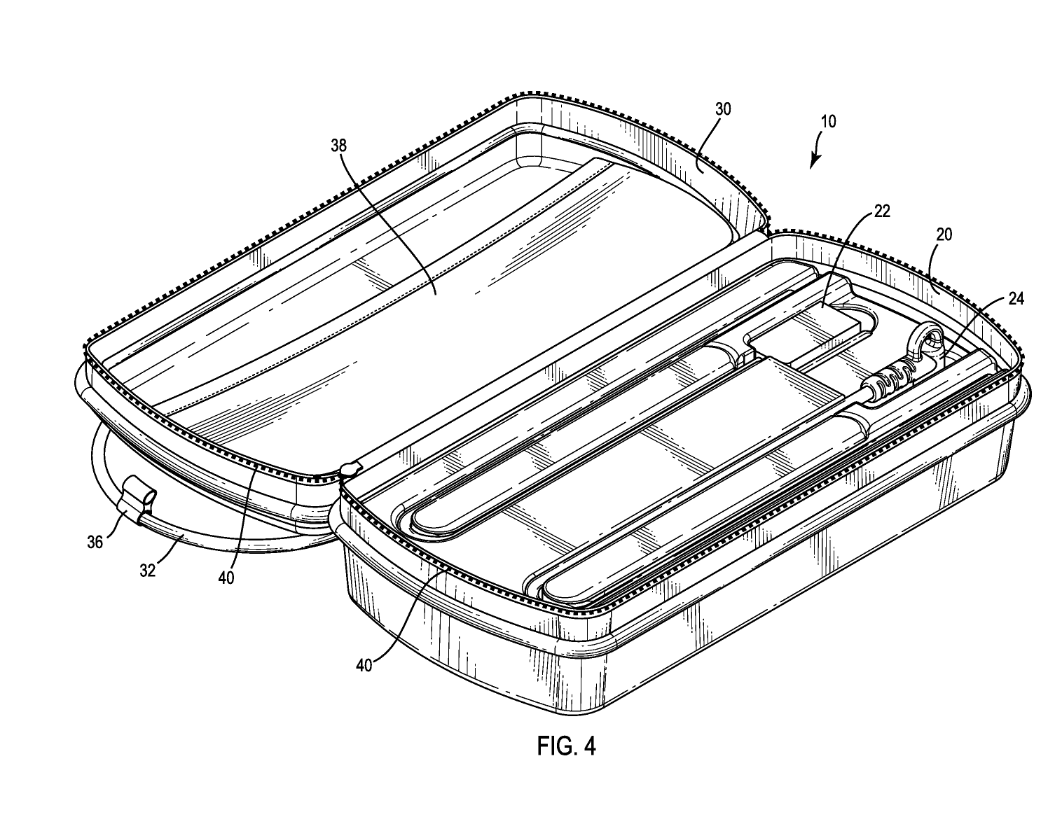

Referring to the exemplary embodiment shown in FIGS. 1-4, a portable speaker assembly 10 includes a first enclosure 20 and a second enclosure 30. First enclosure 20 and second enclosure 30 may be manufactured from a solid material (e.g., plastic, aluminum, etc.), a flexible material (e.g., fabric, etc.), or a combination thereof (e.g., fabric wrapped over a plastic shell, etc.). In one embodiment, first enclosure 20 is coupled to second enclosure 30. As shown in FIGS. 1-4, first enclosure 20 is coupled to second enclosure 30 with a zipper 40. In other embodiments, first enclosure 20 is otherwise coupled to second enclosure 30 (e.g., with opposing magnets, with one or more snaps, etc.). As shown in FIGS. 1-4, first enclosure 20 is at least partially removably coupled to second enclosure 30 such that portable speaker assembly 10 may be configured between a closed arrangement, as shown in FIGS. 1-2, and an open arrangement, as shown in FIGS. 3-4. In other embodiments, portable speaker assembly 10 does not include second enclosure 30.

As shown in FIGS. 2A-3, portable speaker assembly 10 includes a cord 32. Cord 32 facilitates orienting portable speaker assembly 10, according to an exemplary embodiment. In one embodiment, cord 32 is flexible and stretches to accommodate the shape of a structure to which portable speaker assembly 10 is secured. By way of example, cord 32 may be 10 mm bungee cord. As shown in FIGS. 2A-3, cord 32 is coupled to second enclosure 30 with a plurality of interfaces, shown as loops 34. Loops 34 define a plurality of apertures through which cord 32 passes. Loops 34 are formed from a flexible fabric, according to an exemplary embodiment, that is secured (e.g., sewn, adhesively secured, etc.) to second enclosure 30. In other embodiments, loops 34 are formed from another material (e.g., plastic, etc.). In still other embodiments, cord 32 is otherwise coupled to second enclosure 30 (e.g., secured with stitching, secured with an adhesive, etc.).

As shown in FIGS. 2A-3, a plurality of clips 36 join portions of cord 32. In one embodiment, clip 36 defines a pair of apertures configured to receive cord 32. As shown in FIG. 2A, clip 36 defines a pair of through holes that each receive a portion of cord 32. According to the alternative embodiment shown in the sectional view of FIG. 2B, clip 36 defines one through hole configured to receive a first portion of cord 32 and a hook configured to releasably secure a second portion of cord 32. The hook includes a closed bottom portion and an open upper portion. In one embodiment, the open upper portion is installed facing upward (i.e., facing outward). The open upper portion facilitates selectively securing the first portion of cord 32 to the second portion of cord 32. In other embodiments, portable speaker assembly 10 does not include second enclosure 30, and cord 32 is coupled to first enclosure 20. In still other embodiments, portable speaker assembly 10 does not include cord 32 and instead includes another type of positioning device configured to facilitate orienting portable speaker assembly 10.

According to an exemplary embodiment, portable speaker assembly 10 includes a rechargeable battery. In one embodiment, the rechargeable battery is a lithium ion battery having a voltage of 3.7 volts and a capacity of 800 amp hours (3.0 Watt hours). In one embodiment, the rechargeable battery is positioned within first enclosure 20. As shown in FIG. 4, portable speaker assembly 10 includes a power cable, shown as USB cable 22, for charging the rechargeable battery (e.g., using a 5 volt USB source). USB cable 22 includes a male USB connector disposed at one end of the cable and is coupled to the rechargeable battery. By way of example, the male USB connector of USB cable 22 may be coupled to a connector of a solar panel or still another device. An opposing second end of USB cable 22 is secured to first enclosure 20, according to an exemplary embodiment. A device cable, shown as audio cable 24, includes a male 3.5 mm audio jack positioned at a first end of a cable. Audio cable 24 is used to connect portable speaker assembly 10 with an electronic device, according to an exemplary embodiment. In other embodiments, portable speaker assembly 10 otherwise connects with an electronic device (e.g., with Bluetooth, across a Wi-Fi network, etc.). The second end of audio cable 24 is secured to first enclosure 20, according to an exemplary embodiment. In one embodiment, portable speaker assembly 10 includes an audio output cable (e.g., having a female 3.5 mm audio connector) to facilitate chaining electronic devices or portable speaker assemblies 10 together. As shown in FIG. 4, second enclosure 30 defines a pocket 38. Pocket 38 may be used to store an electronic device (e.g., portable music player, cellular telephone, etc.) during use of portable speaker assembly 10. With zipper 40 closed, first enclosure 20 and second enclosure 30 protect the electronic device, USB cable 22, and audio cable 24, thereby reducing the risk of damage thereto.

Referring again to the exemplary embodiment shown in FIG. 1, portable speaker assembly 10 includes a pair of speakers, shown as speakers 50. By way of example, speakers 50 may be 3W stereo speakers. In other embodiments, portable speaker assembly 10 includes only one speaker 50 or more than two speakers 50. Speakers 50 may be powered by the rechargeable battery positioned within first enclosure 20. As shown in FIG. 1, speakers 50 are positioned at least partially within an internal volume defined by first enclosure 20. Speakers 50 may be various types of speakers having various acoustic performance characteristics. In one embodiment, speakers 50 are identical. In another embodiment, the speakers 50 have at least one different characteristic (e.g., size, type, rated power, number of drivers, frequency response, sensitivity, etc.).

As shown in FIG. 1, a cover 60 is disposed over speakers 50. Cover 60 may reduce the risk of damaging inadvertent contact with one or more components of speakers 50 (e.g., cones). As shown in FIG. 1, cover 60 forms a mesh having a honeycomb pattern. In other embodiments, cover 60 defines still another type of pattern (e.g., a rectangular pattern, etc.). Cover 60 may be formed from metallic wire or still another material (e.g., plastic, fibers, etc.).

Referring still to FIG. 1, a bezel 70 is coupled to first enclosure 20 with a plurality of fasteners 72. In one embodiment, bezel 70 couples cover 60 to first enclosure 20. According to an alternative embodiment, cover 60 is otherwise coupled to first enclosure 20. As shown in FIG. 1, bezel 70 contours to the shape of first enclosure 20 and includes an aperture that receives a user interface. As shown in FIG. 1, a cover 74 is positioned to protect the various buttons and components of the user interface. In one embodiment, the user interface is coupled to a controller of portable speaker assembly 10. The user interface may facilitate user control of portable speaker assembly 10 (e.g., volume, etc.) and/or an electronic device coupled thereto (e.g., to select songs to be played by a portable music player).

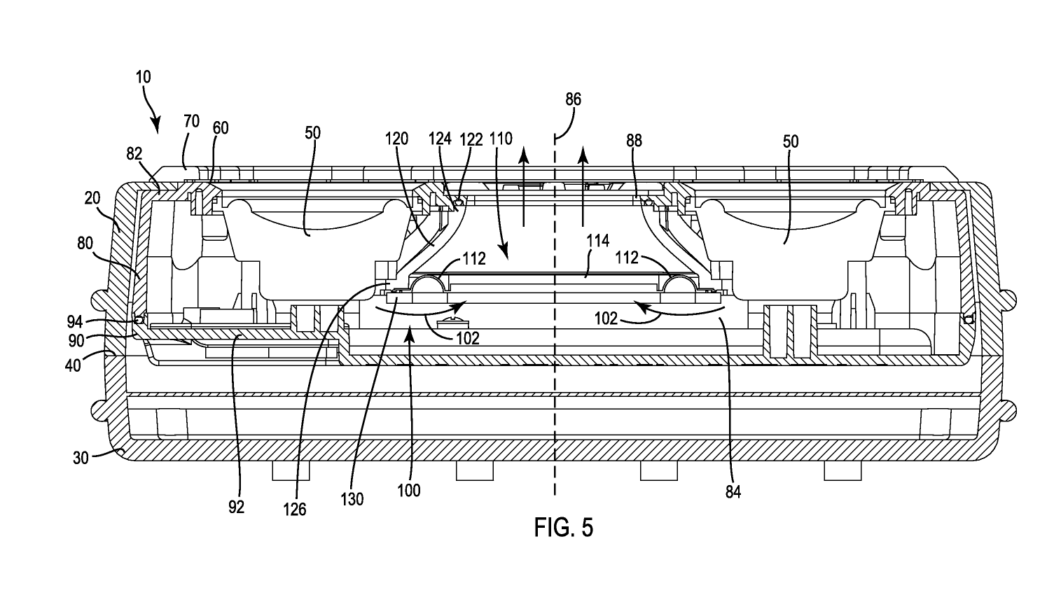

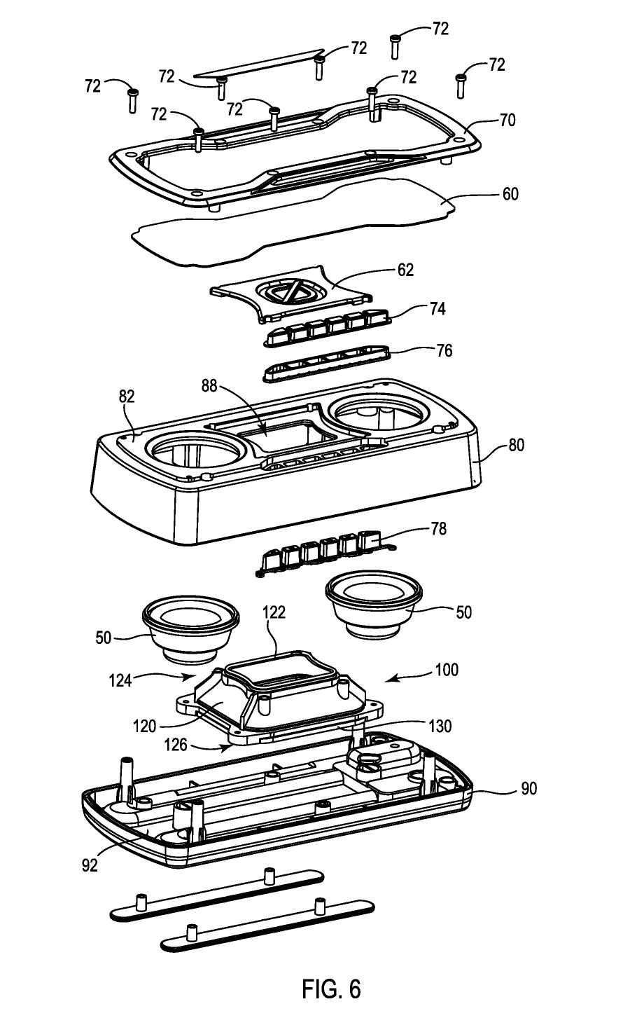

Referring next to FIGS. 5-6, a body (e.g., shell, housing, etc.) is positioned at least partially within first enclosure 20 and includes a first portion 80 and a second portion 90. In one embodiment, first portion 80 and second portion 90 are separate components that are coupled (e.g., adhesively secured, attached with a press fit connection, attached with a snap-fit connection, etc.). According to an alternative embodiment, first portion 80 is integrally formed with second portion 90 and forms a single unitary body.

According to an exemplary embodiment, first portion 80 includes a first plate 82, and second portion 90 includes a second plate 92. First plate 82 is spaced from second plate 92, according to an exemplary embodiment. In one embodiment, first plate 82 defines a first face, and second plate 92 defines an opposing second face. As shown in FIG. 5, first portion 80 and second portion 90 form a body (e.g., shell, housing, etc.) that defines an internal volume 84. The body formed by first portion 80 and second portion 90 also defines a central axis 86.

According to an exemplary embodiment, speakers 50 are coupled to the body formed by first portion 80 and second portion 90. As shown in FIG. 5, speakers 50 are positioned along a surface of first plate 82 and extend toward second plate 92. In another embodiment, speakers 50 at least one of extend inward toward a centerline of portable speaker assembly 10 and extend into internal volume 84 from first plate 82. According to still another embodiment, speakers 50 are sandwiched between first portion 80 and second portion 90.

Referring again to FIGS. 5-6, first portion 80 defines a port, shown as bass port 88. In one embodiment, bass port 88 is configured to facilitate the transmission of sound from internal volume 84. In one embodiment, bass port 88 has a first area (e.g., a first cross-sectional area). The first area may be measured as the cross-sectional area of first portion 80 that is removed to form bass port 88. In other embodiments, the first area is the sectional area within a periphery of first portion 80 that defines bass port 88.

A first speaker 50 is positioned on a first lateral side of central axis 86, and a second speaker 50 is positioned on a second lateral side of central axis 86, according to the exemplary embodiment shown in FIG. 5. The first speaker 50 may be spaced an offset distance from the second speaker 50. In one embodiment, bass port 88 at least partially spans central axis 86. According to an alternative embodiment, bass port 88 is defined by first portion 80 in another location. In either embodiment, speakers 50 may be positioned on opposing lateral sides of bass port 88 (i.e., bass port 88 may be positioned between speakers 50).

According to the exemplary embodiment shown in FIG. 6, a plate 62 is disposed over bass port 88. In one embodiment, plate 62 includes brand-specific indicia. Plate 62 may define a plurality of apertures (e.g., in the shape of a company logo) intended to facilitate the transmission of sound waves from internal volume 84. According to an alternative embodiment, portable speaker assembly 10 does not include plate 62.

Referring still to the exemplary embodiment shown in FIG. 6, a support 76 is positioned to couple a plurality of user interfaces, shown as buttons 78, to first plate 82. As shown in FIG. 6, cover 74 is positioned to protect buttons 78 during operation or transportation of portable speaker assembly 10. In one embodiment, buttons 78 are coupled to various circuits and processors that translate the user input (e.g., volume control, song selection, etc.) into one or more signals. Such signals may be communicated to speakers 50 or to the electronic device to implement the user requested action.

As shown in FIGS. 5-6, a passive radiator, shown as passive radiator 100 is disposed within internal volume 84. Passive radiator 100 improves the low-frequency acoustic performance of portable speaker assembly 10, according to an exemplary embodiment. As shown in FIG. 5, passive radiator 100 is positioned to direct sound at least one of toward and through bass port 88 defined by first portion 80. In one embodiment, passive radiator 100 is sandwiched between first portion 80 and second portion 90. As shown in FIG. 5, passive radiator 100 may be sandwiched between first portion 80 and second portion 90 and positioned between speakers 50.

According to the exemplary embodiment shown in FIG. 5, passive radiator 100 and speakers 50 direct sound waves along a common direction. As shown in FIG. 5, bass port 88 is defined within first plate 82 of first portion 80. Speakers 50 are positioned to direct sound through a pair of apertures in first plate 82 such that passive radiator 100 and speakers 50 direct sound along a common direction. In other embodiments, passive radiator 100 and speakers 50 direct sound along a common direction that extends through another portion of portable speaker assembly 10. By way of example, bass port 88 may be defined within a sidewall of first portion 80, and speakers 50 may be positioned to direct sound through a pair of apertures in the sidewall. By way of another example, bass port 88 may be defined within second plate 92 of second portion 90, and speakers 50 may be positioned to direct sound through a pair of apertures in second plate 92.

According to an alternative embodiment, passive radiator 100 and speakers 50 direct sound waves along different directions. By way of example, bass port 88 may be defined within first plate 82 of first portion 80, and speakers 50 may be positioned to direct sound through a pair of apertures in a sidewall of first portion 80. By way of another example, bass port 88 may be defined within a sidewall of first portion 80, and speakers 50 may be positioned to direct sound through a pair of apertures in first plate 82.

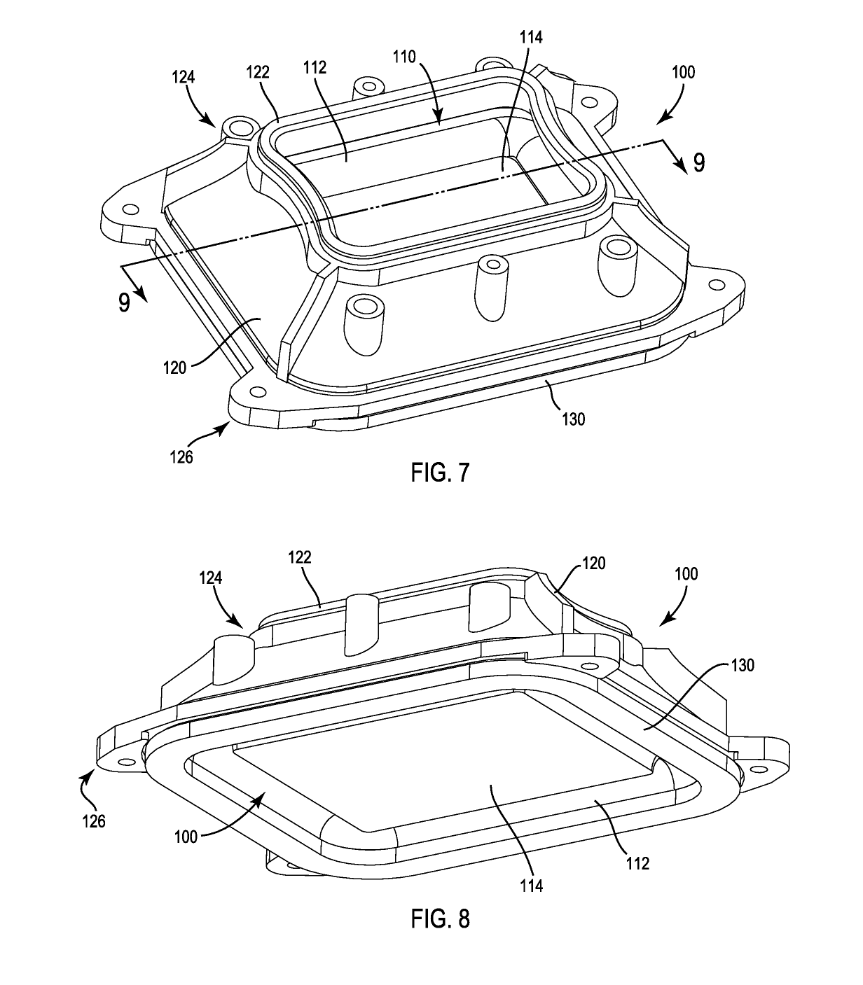

Referring to FIGS. 5-9, passive radiator 100 includes a membrane, shown as membrane 110. According to the exemplary embodiment shown in FIGS. 5-9, membrane 110 is coupled to a conduit, shown as horn 120, with a clamp, shown as clamp 130. As shown in FIG. 5, membrane 110 is positioned between first plate 82 and second plate 92. In one embodiment, membrane 110 is configured to direct sound toward bass port 88. Membrane 110 is configured to actuate during operation of speakers 50. By way of example, at least a portion of membrane 110 may be formed from a flexible material. By way of another example, membrane 110 may include one or more components moveably coupled to horn 120 or another portion of portable speaker assembly 10.

Movable portions of speakers 50 (e.g., cones thereof) actuate during operation. Such actuation produces pressure variations within internal volume 84. As shown in FIG. 5, pressure waves 102 are produced by the actuation of speakers 50. Pressure waves 102 engage membrane 110 and actuate at least a portion thereof. As shown in FIG. 5, pressure waves 102 are positive pressure waves (e.g., indicating a pressure that is greater than the pressure within horn 120, indicating a pressure that is greater than an ambient pressure, etc.) that actuate membrane 110 to produce sound waves 104. Membrane 110 may return to a steady state condition once the pressure within internal volume 84 equalizes with the pressure within horn 120. In one embodiment, horn 120 directs sound waves 104 through bass port 88 to improve the acoustic performance of portable speaker assembly 10. Sound waves 104 may have a low frequency, thereby improving the low-end performance of portable speaker assembly 10.

According to an exemplary embodiment, second portion 90 defines a channel that guides (e.g., funnels, etc.) pressure waves 102 toward membrane 110. In one embodiment, pressure waves 102 are produced as cones of speakers 50 are actuated by corresponding drivers. Pressure waves 102 may be initially directed downward (e.g., away from first plate 82) toward second plate 92. In one embodiment, pressure waves 102 are reflected from second portion 90 and engage membrane 110.

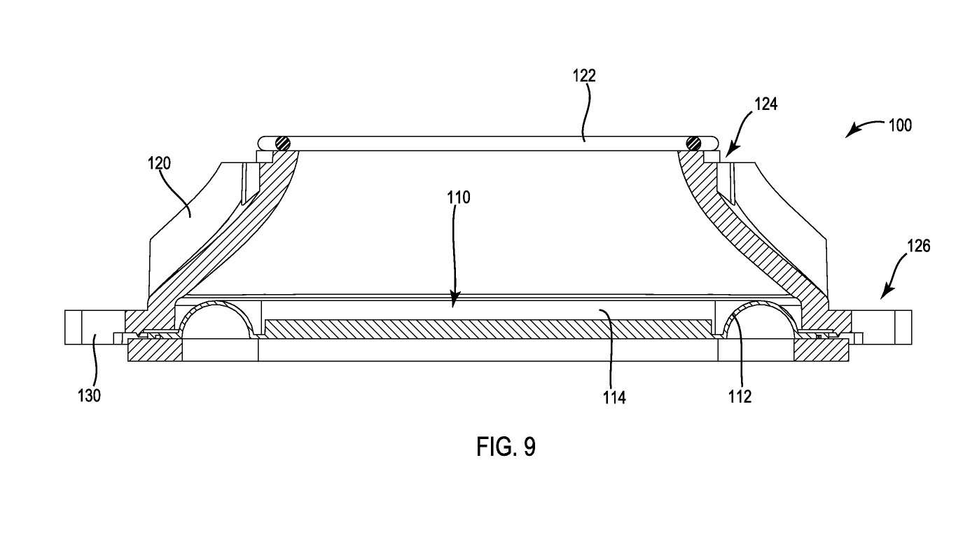

According to an exemplary embodiment, the various components of portable speaker assembly 10 are substantially sealed to facilitate the engagement of pressure variations with membrane 110. As shown in FIG. 5, a seal 94 is positioned at the union between first portion 80 and second portion 90. A seal is also positioned between speakers 50 and first plate 82, according to an exemplary embodiment. As shown in FIGS. 5 and 9, a seal 122 is also positioned at a proximal end 124 of horn 120. Membrane 110 may be continuous and sealed to a distal end 126 of horn 120 by clamp 130. According to an alternative embodiment, portable speaker assembly 10 includes at least one of an adhesive and a sealant (e.g., a rubber or synthetic material, etc.) to substantially seal internal volume 84 defined by first portion 80 and second portion 90. Membrane 110 and the various seals may also reduce the risk of water infiltration, thereby protecting the various electronic components (e.g., circuit boards, drivers of speakers 50, batteries, etc.) that may be positioned within internal volume 84.

Membrane 110 includes a bellow portion 112 disposed around a middle portion 114, according to the exemplary embodiment shown in FIGS. 5-9. In one embodiment, bellow portion 112 and middle portion 114 are integrally formed as a single unitary body. Bellow portion 112 may be formed from a flexible material. As shown in FIGS. 5 and 9, bellow portion 112 has an arcuate cross-sectional shape and has an outer periphery that is fixed to horn 120. An internal periphery of bellow portion 112 is coupled to middle portion 114.

During operation of speakers 50, pressure variations generated by speakers 50 engage a surface of membrane 110 that forms a portion of internal volume 84. By way of example, the pressure variations may engage an underside of membrane 110. The pressure variations engage the underside of bellow portion 112 and middle portion 114 thereby actuating membrane 110. In one embodiment, positive pressure variations uncurl bellow portion 112 and generate upward movement of middle portion 114 (e.g., movement toward first plate 82). As shown in FIG. 8, middle portion 114 is planar such that pressure variations act substantially uniformly across membrane 110.

According to the exemplary embodiment shown in FIG. 5, membrane 110 extends in a generally horizontal direction. By way of example, at least a portion of membrane 110 (e.g., middle portion 114, etc.) may extend within a plane that is orthogonal to central axis 86. By way of another example, at least a portion of membrane 110 may extend in a plane that is parallel to at least one of first plate 82 and second plate 92. In one embodiment, first plate 82, second plate 92, and at least a portion of membrane 110 are parallel to one another. According to an alternative embodiment, membrane 110 is angularly offset relative to at least one of first plate 82 and second plate 92. By way of example, membrane 110 may extend in a generally vertical direction while at least one of first plate 82 and second plate 92 may extend in a generally horizontal direction. Membrane 110 having a vertical orientation may produce sound waves 104 that travel at least initially toward a sidewall of first portion 80 or second portion 90. Horn 120 may be at least one of shaped and positioned to direct sound waves 104 produced by membrane 110 in an upward direction (e.g., toward a bass port 88 defined by first plate 82) or laterally outward (e.g., toward a bass port 88 defined within a sidewall of at least one of first portion 80 and second portion 90). According to still another alternative embodiment, membrane 110 extends in still another direction and produces sound waves 104 in still another direction. Horn 120 may direct such sound waves 104 toward bass port 88 defined in one of the various plates and sidewalls of first portion 80 and second portion 90.

As shown in FIG. 8, clamp 130 is annular and has generally rectangular shape. Clamp 130 also has a generally rectangular cross-sectional shape, according to an exemplary embodiment. Clamp 130 is compressed during installation of passive radiator 100 and imparts a clamping force on the periphery of membrane 110, thereby reducing the risk of movement thereof, according to an exemplary embodiment. In other embodiments, membrane 110 is otherwise coupled to horn 120 (e.g., integrally formed with horn 120, adhesively secured to horn 120, etc.).

As shown in FIG. 5, membrane 110 has an area that is larger than the first area of bass port 88. By way of example, membrane 110 may have at least one of a cross-sectional area and a surface area that is larger than the first area of bass port 88. Membrane 110 having an increased area may be more sensitive to pressure variations within internal volume 84. As shown in FIG. 5, membrane 110 is offset from first plate 82. The offset membrane 110 may reduce an exterior space claim of passive radiator 100 (e.g., the area on an outer surface of first enclosure 20 and second enclosure 30 consumed by passive radiator 100) without reducing the sensitivity and performance thereof. In other embodiments, the offset membrane 110 may facilitate reducing the size of portable speaker assembly 10.

Referring again to FIG. 5, horn 120 is shaped to direct sound waves 104 through bass port 88. As shown in FIG. 5, horn 120 extends between bass port 88 and membrane 110. By way of example, proximal end 124 of horn 120 may be coupled to a periphery of first plate 82 that defines bass port 88. Distal end 126 of horn 120 may be coupled to second plate 92. According to an exemplary embodiment, membrane 110 is coupled to distal end 126 of horn 120. In one embodiment, membrane 110 spans distal end 126 of horn 120. By way of example, membrane 110 may extend entirely across distal end 126 of horn 120.

Horn 120 has a cross-sectional area that varies along its height, according to an exemplary embodiment. Horn 120 has a first cross-sectional area at proximal end 124 and a second cross-sectional area at distal end 126. According to the exemplary embodiment shown in FIGS. 5-9, the cross-sectional area of horn 120 increases as it extends from bass port 88 to membrane 110 such that the second cross-sectional area is greater than the first cross sectional area. In one embodiment, the cross-sectional area of horn 120 varies linearly along its height. According to the alternative embodiment shown in FIGS. 5-9, the cross-sectional area of horn 120 varies non-linearly along its height. In one embodiment, horn 120 includes a curved sidewall shaped to direct sound waves 104 through bass port 88.

According to the exemplary embodiment shown in FIGS. 5-6, horn 120 has a shape that contours speakers 50. Portable speaker assembly 10 having a horn 120 that contours speakers 50 may have an increased acoustic performance. In one embodiment, horn 120 includes a sidewall having a shape that contours speakers 50. By way of example, speakers 50 may have a first cross-sectional shape, and the sidewall of horn 120 may have a second cross-sectional shape. In one embodiment, the second cross-sectional shape is a negative of the first cross-sectional shape. As shown in FIG. 5, speakers 50 taper as they extend from first plate 82 while horn 120 expands as it extends from first plate 82.

According to an alternative embodiment, horn 120 is shaped to direct sound waves 104 produced by membrane 110 toward a bass port 88 that is otherwise positioned on portable speaker assembly 10. By way of example, bass port 88 may be defined within a sidewall of first portion 80. Horn 120 may be curved and extend between membrane 110 and bass port 88 defined within the sidewall of first portion 80. Such a horn 120 may have a first area (e.g., a first cross-sectional area) at bass port 88 and a second area (e.g., a second cross-sectional area) at membrane 110. The second area is larger than the first area, according to an exemplary embodiment. According to alternative embodiments, the second area is smaller than or equal in size to the first area, depending on the size and shape of bass port 88.

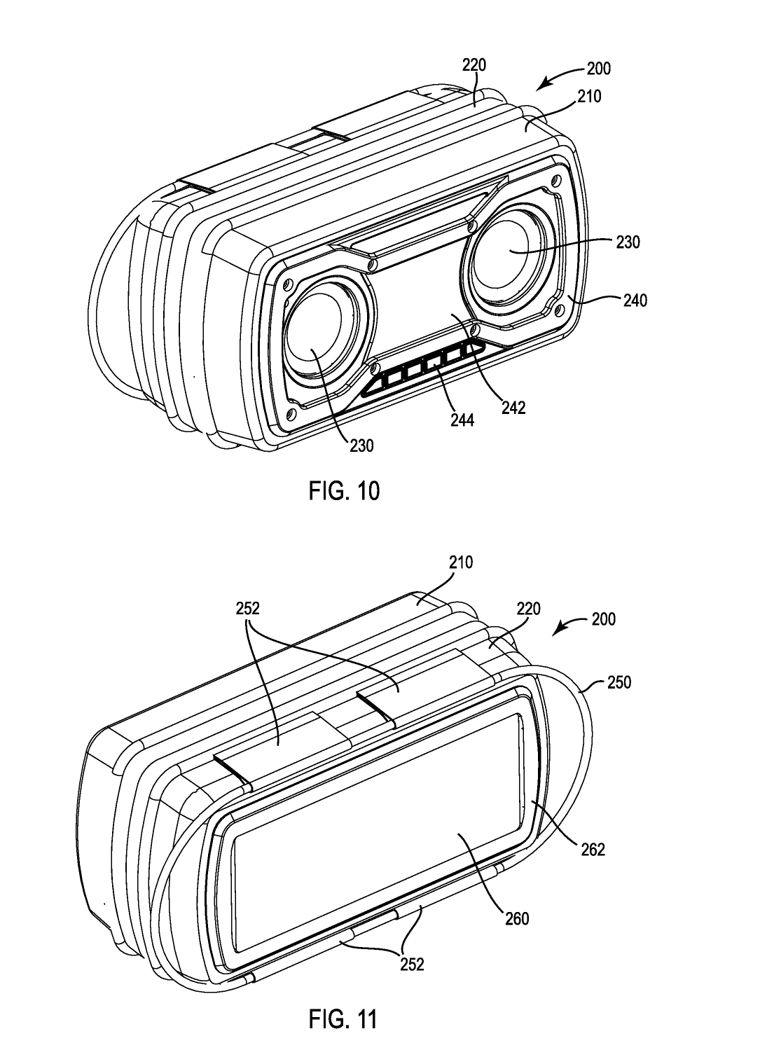

According to the alternative embodiment shown in FIGS. 10-11, a portable speaker assembly 200 includes a first enclosure 210 and a second enclosure 220. In one embodiment, first enclosure 210 and second enclosure 220 define an internal volume, and a passive radiator assembly is disposed within the internal volume. As shown in FIG. 10, portable speaker assembly 200 includes a pair of speakers 230 coupled to first enclosure 210. A bezel 240 is coupled to first enclosure 210, and a cover 242 is disposed over a bass port of the passive radiator assembly. Cover 242 may include an aperture (e.g., in the shape of brand-specific indicia) to facilitate the transmission of sound waves from the internal volume of first enclosure 210 and second enclosure 220. As shown in FIG. 10, a cover 244 is positioned to protect the various buttons and components of a user interface.

As shown in FIG. 11, portable speaker assembly 200 includes a cord 250. Cord 250 facilitates orienting portable speaker assembly 200, according to an exemplary embodiment. In one embodiment, cord 250 is flexible and stretches to accommodate the shape of a structure to which portable speaker assembly 200 is secured. As shown in FIG. 11, cord 250 is coupled to second enclosure 220 with a plurality of interfaces, shown as loops 252. Loops 252 define a plurality of apertures through which cord 250 passes, according to an exemplary embodiment.

Referring again to FIG. 11, portable speaker assembly 200 includes a solar panel 260. Solar panel 260 is disposed along an outer surface of second enclosure 220, according to an exemplary embodiment. According to an exemplary embodiment, first enclosure 210 is movably coupled to second enclosure 220 such that portable speaker assembly 200 may be arranged in a first configuration and a second configuration. In the first configuration, shown in FIGS. 11-12, speakers 230 and solar panel 260 are on opposing sides of portable speaker assembly 200. From the first arrangement, portable speaker assembly 200 may be opened into a second arrangement such that speakers 230 and solar panel 260 both face upward. In the second arrangement, portable speaker assembly 200 facilitates use of both speakers 230 and solar panel 260. Accordingly, a user may play music with speakers 230 without precluding the use of solar panel 260.

In one embodiment, portable speaker assembly 200 includes a rechargeable battery that is electrically coupled to solar panel 260. In one embodiment, the rechargeable battery is used to power speakers 230, and solar panel 260 is used to charge the rechargeable battery. In other embodiments, solar panel 260 is used to directly power speakers 230, and portable speaker assembly 200 does not include a rechargeable battery. In still other embodiments, solar panel 260 may selectively charge the rechargeable battery and directly power speakers 230. As shown in FIG. 11, a bezel 262 is positioned around solar panel 260. Bezel 262 may be used to protect solar panel 260 from damage.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

What is claimed is:

1. A portable speaker assembly, comprising:
a body including a first plate spaced from a second plate, wherein a surface of the body defines a port having a first cross-sectional area;
a speaker disposed along a surface of the first plate and extending toward the second plate; and
a membrane configured to direct sound waves toward the port and positioned between the first plate and the second plate, wherein the membrane has a second cross-sectional area that is larger than the first cross-sectional area of the port.

2. The portable speaker assembly of claim 1, further comprising a conduit extending between the port and the membrane.

3. The portable speaker assembly of claim 2, wherein the conduit has a proximal end and a distal end, and wherein the membrane is coupled to the distal end of the conduit.

4. The portable speaker assembly of claim 3, wherein the membrane spans the distal end of the conduit.

5. The portable speaker assembly of claim 3, wherein the proximal end of the conduit is coupled to the first plate.

6. The portable speaker assembly of claim 3, wherein a cross-sectional area of the conduit increases as it extends from the port to the membrane.

7. The portable speaker assembly of claim 6, wherein the cross-sectional area of the conduit increases from the first cross-sectional area at the proximal end to the second cross-sectional area at the distal end.

8. The portable speaker assembly of claim 1, further comprising a second speaker disposed along the surface of the first plate and extending toward the second plate, wherein the second speaker is spaced from the first speaker.

9. The portable speaker assembly of claim 8, wherein the port is positioned between the first speaker and the second speaker.

10. The portable speaker assembly of claim 9, further comprising a conduit extending between the port and the membrane, wherein the conduit has a shape that contours the first speaker and the second speaker.

11. A portable speaker assembly, comprising:
a shell including a first face and an opposing second face, wherein the shell defines an internal volume and a port having a first cross-sectional area;
a speaker disposed along the first face and extending toward the opposing second face; and
a membrane configured to direct sound waves toward the port and positioned within the internal volume of the shell, wherein the membrane has a second cross-sectional area that is larger than the first cross-sectional area of the port.

12. The portable speaker assembly of claim 11, further comprising a conduit extending between the port and the membrane.

13. The portable speaker assembly of claim 12, wherein the conduit has a proximal end and a distal end, and wherein the membrane is coupled to the distal end of the conduit.

14. The portable speaker assembly of claim 12, wherein a cross-sectional area of the conduit increases as it extends from the port to the membrane.

15. The portable speaker assembly of claim 12, wherein the conduit extends between a proximal end and a distal end, wherein a cross-sectional area of the conduit increases from the first cross-sectional area at the proximal end to the second cross-sectional area at the distal end.

16. A portable speaker assembly, comprising:
a housing defining an internal volume and a bass port;
a first speaker coupled to the housing and positioned on a first lateral side of the bass port;
a second speaker coupled to the housing and positioned on a second lateral side of the bass port; and
a passive radiator including a membrane and configured to direct sound waves through the bass port, wherein the membrane is disposed within the internal volume of the housing and has a cross-sectional area that is larger than the bass port.

17. The portable speaker assembly of claim 16, wherein the passive radiator includes a conduit extending between the bass port and the membrane.

18. The portable speaker assembly of claim 17, wherein the conduit has a shape that contours the first speaker and the second speaker.

19. The portable speaker assembly of claim 17, wherein the conduit has a shape that tapers as it extends from a distal end at the membrane to a proximal end at the bass port.

20. The portable speaker assembly of claim 17, wherein the conduit extends between a distal end at the membrane and a proximal end at the bass port, wherein the distal end of the conduit has a first cross-sectional area and the proximal end of the conduit has a second cross-sectional area, and wherein the first cross-sectional area is larger than the second cross-sectional area.
